(19) United States
(12) Patent Application Publication
(10) Pub. No.: US 2023/0311392 A1
(43) Pub. Date: Oct. 5, 2023

(54) INJECTION MOLDING SYSTEM

(71) Applicant: FANUC CORPORATION, Yamanashi (JP)

(72) Inventor: Yasumasa NAGANO, Yamanashi (JP)

(73) Assignee: FANUC CORPORATION, Yamanashi (JP)

(21) Appl. No.: 18/043,919

(22) PCT Filed: Sep. 3, 2021
(86) PCT No.: PCT/JP2021/032401

§ 371 Date: Mar. 3, 2023

(30) Foreign Application Priority Data
Sep. 8, 2020 (JP) 2020-150668

(51) Int. Cl. B29C 45/84; B29C 45/76; B29C 45/42

(52) U.S. Cl. CPC B29C 45/84; B29C 45/76; B29C 45/42; B29C 2045/4266

(57) ABSTRACT

An injection molding system includes: an injection molding machine; a collaborative robot installed outside or inside the injection molding machine; and a control unit that controls the collaborative robot. Before the injection molding machine is brought into operation, the control unit operates the collaborative robot at least in a space inside the injection molding machine where molds are installed, and transmits an operation disable signal to the injection molding machine when contact between an object and the collaborative robot or a hand attached to an end of the collaborative robot is detected.

### TECHNICAL FIELD

The present disclosure relates to an injection molding system.

### BACKGROUND

In a known injection molding system, in order to detect that there is no operator left inside a safety door, a light curtain is disposed at least in an area on the side opened by an opening action of the safety door (for example, see Japanese Unexamined Patent Application Publication No. 2017-205932).

### SUMMARY

An aspect of the present disclosure is an injection molding system including: an injection molding machine; a collaborative robot installed outside or inside the injection molding machine; and a control unit that controls the collaborative robot. Before the injection molding machine is brought into operation, the control unit operates the collaborative robot at least in a space inside the injection molding machine where molds are installed and transmits an operation disable signal to the injection molding machine when contact between an object and the collaborative robot or a hand attached to an end of the collaborative robot is detected.

### BRIEF DESCRIPTION OF DRAWINGS

FIG. 1 is a front view showing an injection molding system according to an embodiment of the present disclosure.

FIG. 2 is a front view showing an example of an area where a collaborative robot performs an object detecting operation in an injection molding machine provided in the injection molding system in FIG. 1.

FIG. 3 is a plan view showing an example of an operation path of the collaborative robot in the object detecting operation in FIG. 2.

FIG. 4 is a flowchart for explaining the operation of the injection molding system in FIG. 1.

FIG. 5 is a front view for explaining another example of the area where the collaborative robot performs the object detecting operation in the injection molding machine of the injection molding system in FIG. 2.

### DESCRIPTION OF EMBODIMENTS

An injection molding system 1 according to an embodiment of the present disclosure will be described below with reference to the drawings.

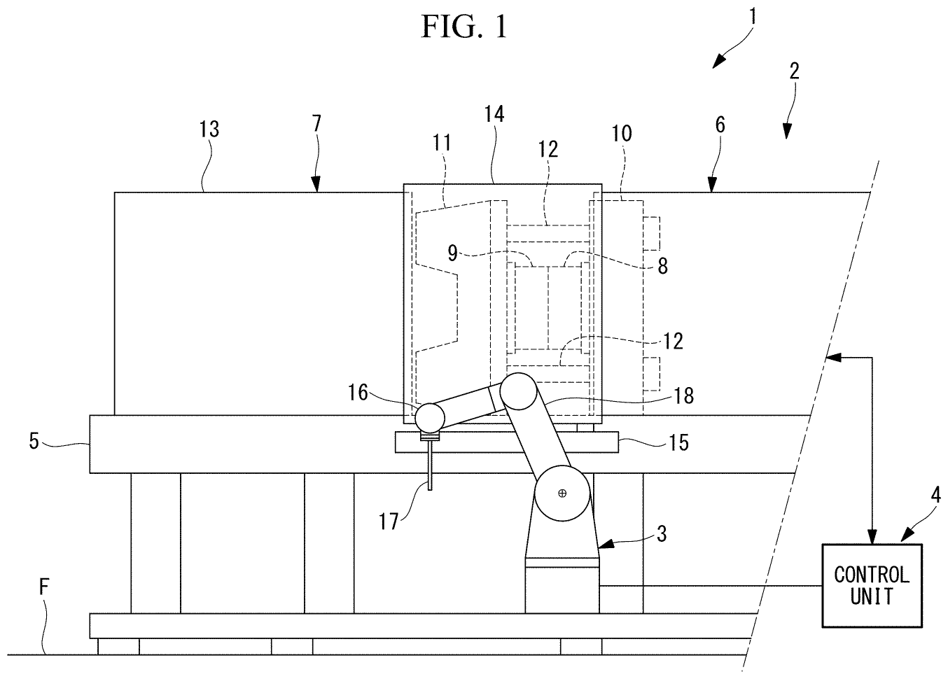

As shown in FIG. 1, the injection molding system 1 according to this embodiment includes an injection molding machine 2, a collaborative robot 3 installed outside the injection molding machine 2, and a control unit 4 that controls the collaborative robot 3.

The injection molding machine 2 includes a machine base 5 installed on a floor F, and an injecting part 6 and a clamping unit 7 installed on the machine base 5. The injecting part 6 injects molten resin into a cavity between molds 8 and 9 provided in the clamping unit 7.

The clamping unit 7 includes a stationary platen 10 that is fixed to the machine base 5 and supports one mold 8, and a moving platen 11 that is disposed so as to be movable in the horizontal direction with respect to the stationary platen 10 and supports the other mold 9. The moving platen 11 is supported by four tie bars 12 extending in the horizontal direction so as to be movable in the horizontal direction with respect to the stationary platen 10.

By bringing the stationary platen 10 and the moving platen 11 toward each other, the pair of molds 8 and 9 are combined, forming the cavity between the molds 8 and 9. After molten resin is injected into the cavity to form a molded article, the moving platen 11 is moved in a direction away from the stationary platen 10. As a result, the molds 8 and 9 are opened, and the molded article can be taken out of the molds 8 and 9.

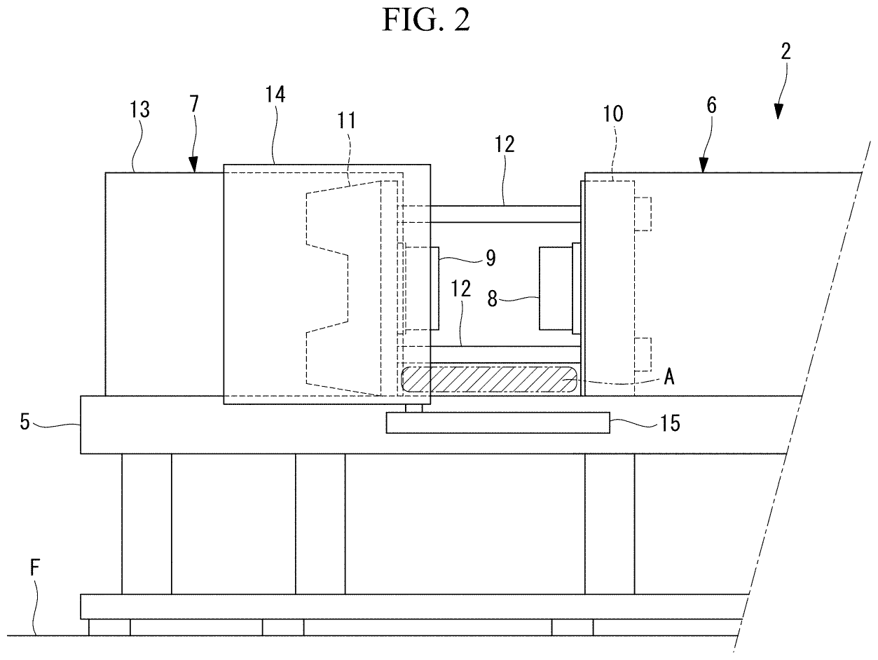

The clamping unit 7 includes a cover 13 that covers at least a portion of the outer periphery, and a safety door 14 that can be opened and closed. In the drawings, reference sign 15 denotes a guide device that drives the safety door 14 in the horizontal direction. As shown in FIG. 2, the stationary platen 10, the moving platen 11, and the pair of molds 8 and 9 disposed inside the cover 13 can be viewed from the outside by opening the safety door 14.

When the injection molding machine 2 is brought into operation, as shown in FIG. 1, the safety door 14 is moved in the closing direction and closed, thus restricting contact between an operator and the stationary platen 10, the moving platen 11, and the pair of molds 8 and 9 inside the injection molding machine 2. Furthermore, when parts are to be set in the molds 8 and 9 to perform insert molding or when a molded article is to be taken out of the molds 8 and 9, the safety door 14 is moved in the opening direction and opened, as shown in FIG. 2. By doing so, it is possible to expose the pair of molds 8 and 9, which are separated in the horizontal direction, to the outside of the cover 13.

The collaborative robot 3 is, for example, a vertical six-axis articulated robot and is installed outside the injection molding machine 2, at a position in the vicinity of the safety door 14. The operation area of the collaborative robot 3 extends over the outside and the inside of the injection molding machine 2. The collaborative robot 3 is provided with, at the end of a wrist 16, a tool, such as a hand 17 for taking out a molded article produced by the injection molding machine 2 from the molds 8 and 9.

The collaborative robot 3 accommodates a six-axis force sensor (not shown). Contact of an operator or an outside object with the surface or the hand 17 of the collaborative robot 3 fluctuates the detection value of the force sensor, thus making it possible to detect contact with any object. The collaborative robot 3 is operated at a sufficiently low speed and is controlled to stop or slow down when the force sensor detects any contact.

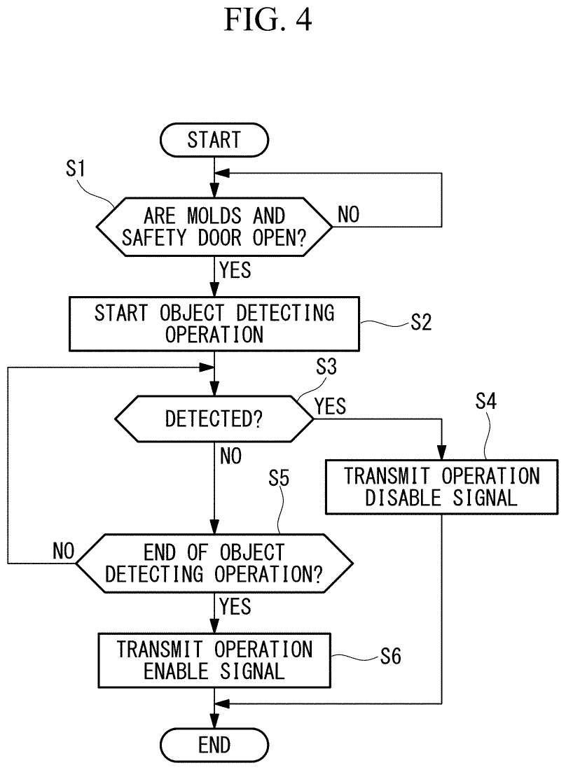

The control unit 4 includes a memory (storage unit) that stores a preliminarily taught program, and at least one processor for operating the collaborative robot 3 in accordance with the program stored in the memory. The processor generates a path on the basis of the program, more specifically, the arrangement of the members in the space where the molds 8 and 9 are installed, stored in the memory. Furthermore, as shown in FIG. 4, the control unit 4 operates the collaborative robot 3 upon receipt of an opening signal for the safety door 14 and an opening signal for the molds 8 and 9 from the injection molding machine 2 (step S1).

In the injection molding system 1 according to this embodiment, before the injection molding machine 2 is brought into operation, that is, before an injection molding operation by the injection molding machine 2 is started, the control unit 4 causes the collaborative robot 3 to perform an object detecting operation (step S2). The object detecting operation is an operation for detecting the presence/absence of an unexpected object in the space inside the injection molding machine 2 by controlling the collaborative robot 3 in accordance with the program stored in the memory.

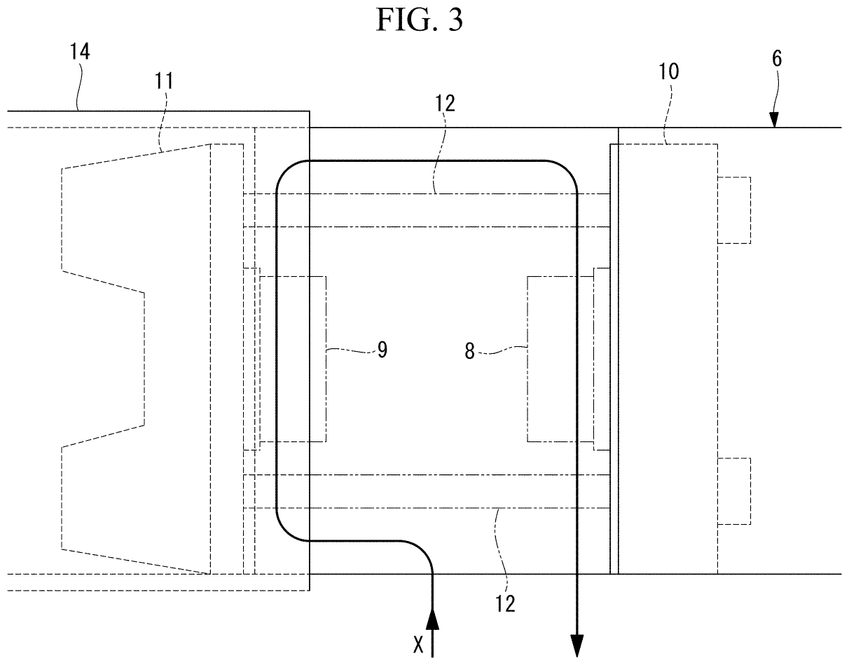

More specifically, the object detecting operation is an operation of the collaborative robot 3 in which the control unit 4 causes the tool center point (TCP) set to the hand 17 to move along, for example, a path X shown in FIG. 3. By moving the TCP along this path X, it is possible to pass the arm 18, the wrist 16, or the hand 17 of the collaborative robot 3 over substantially the entire area A, which is separated by fine gaps from inner surfaces of a space extending in the horizontal direction between the top surface of the machine base 5 and the tie bars 12 below the molds 8 and 9.

The control unit 4 determines whether the collaborative robot 3 has detected contact with any object during the object detecting operation on the basis of the signal from the force sensor (step S3). When it is determined that contact has been detected, the control unit 4 transmits an operation disable signal to the injection molding machine 2 (step S4), and the processing is terminated.

In step S3, when it is determined that no contact has been detected, the process in step S3 is repeated until the object detecting operation ends (step S5). When the collaborative robot 3 detects no contact with any object until the object detecting operation ends, the control unit 4 transmits an operation enable signal to the injection molding machine 2 (step S6), and the processing is terminated.

The injection molding machine 2 does not start the injection molding operation when an operation disable signal has been transmitted from the control unit 4. In contrast, the injection molding machine 2 automatically starts the injection molding operation when an operation enable signal has been transmitted from the control unit 4.

The operation of the thus-configured injection molding system 1 according to this embodiment will be described.

In the injection molding system 1 according to this embodiment, before the injection molding machine 2 performs the injection molding operation, the collaborative robot 3 is operated in the space where the molds 8 and 9 are disposed.

As shown in FIG. 3, because the collaborative robot 3 is operated over substantially the entire area along the path X, along which the arm 18, the wrist 16, or the hand 17 passes, except for the vicinity of the inner surfaces of the space where the molds 8 and 9 are disposed in plan view of the space, it is possible to detect the presence/absence of an object in the space. This leads to an advantage in that it is possible to more reliably prevent the injection molding machine 2 from being brought into operation while an operator or an unexpected object is left in the space.

Specifically, because detection is performed by directly touching the object in the space with the collaborative robot 3 itself or the hand 17 attached to the collaborative robot 3, unlike detection using an optical sensor, precise detection is possible even when the illumination is changed. Furthermore, because the presence of an object in the space is detected with the collaborative robot 3, there is no need to separately manage the entry/exit of an object into/from the space, unlike detection with a light curtain.

Although a six-axis articulated robot has been described as an example of the collaborative robot 3 in this embodiment, the type of the robot is not limited thereto, and a robot of any type may be employed.

Furthermore, an example case where the collaborative robot 3 is operated only in the lower part of the space where the molds 8 and 9 are disposed, i.e., the area A in the space, has been described. When the object to be detected is an operator, because the operator typically works with his/her feet on the top surface of the machine base 5, by operating the collaborative robot 3 only at the lower part, which is close to the top surface of the machine base 5, the presence/absence of an operator can be efficiently detected.

Instead, the collaborative robot may be operated not only in the lower part of the space, but also in an area wider than the area A in the space, into which the arm 18, the wrist 16, or the hand 17 can be inserted. By doing so, it is possible to detect an operator whose feet are not on the floor F, such as when he/she is standing on the tie bars 12, or to detect an object, such as a fixture or an inspection device that should have been removed when the robot is brought into operation, remaining attached to the molds 8 and 9 or the like.

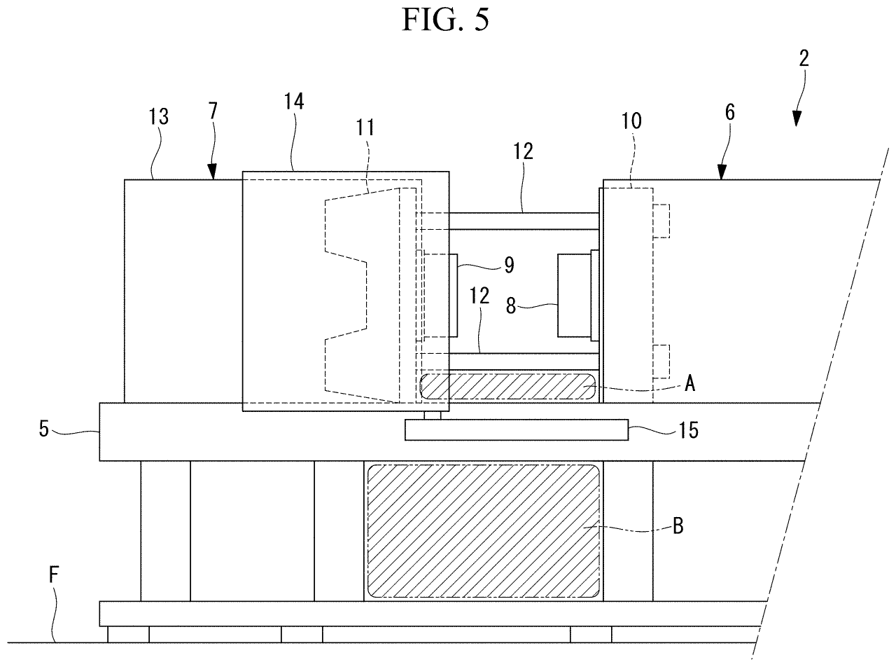

Furthermore, in this embodiment, the space above the machine base 5 is shown as an example of the space where the molds 8 and 9 are disposed. In addition to this, when the space inside the machine base 5 is continuous with the space inside the clamping unit 7, as shown in FIG. 5, the collaborative robot 3 may be operated also in the space inside the machine base 5.

In the case where molded articles are randomly dropped, sometimes a product drop port area B, serving as a space for placing a container for storing the molded articles or a conveyor for transporting the molded articles, is provided inside the machine base 5. By making the collaborative robot 3 perform an object detecting operation also in the space inside the machine base 5, it is possible to reliably prevent accidental entry of an operator who has been working in the product drop port area B before the injection molding machine 2 is brought into operation into the space inside the clamping unit 7 during the operation of the injection molding machine 2.

Furthermore, in this embodiment, the object detecting operation may be preliminarily stored in the memory by teaching. Alternatively, in a state in which the safety in the space where the molds 8 and 9 are disposed or in the space inside the machine base 5 is confirmed, the collaborative robot 3 may be operated to search for the positions of the members, such as the molds 8 and 9 and the tie bars 12, inside the space by using a contact detection function of the collaborative robot 3, and the positions may be stored in the memory.

Alternatively, three-dimensional data of the positions of the members, such as the molds and the tie bars 12 in the space, may be formed off-line by means of three-dimensional CAD or the like and stored in the memory. The control unit 4 may automatically generate an object detecting operation on the basis of the positions of the members stored in the memory.

In this embodiment, although an example in which the collaborative robot 3 is installed outside the injection molding machine 2 has been described, a system in which the collaborative robot 3 is installed inside the injection molding machine 2 may be employed.

1. An injection molding system comprising:
an injection molding machine;
a collaborative robot installed outside or inside the injection molding machine; and
a control unit that controls the collaborative robot, wherein
before the injection molding machine is brought into operation, the control unit operates the collaborative robot at least in a space inside the injection molding machine where molds are installed, and transmits an operation disable signal to the injection molding machine when contact between an object and the collaborative robot or a hand attached to an end of the collaborative robot is detected.

2. The injection molding system according to claim 1, wherein, when the control unit operates the collaborative robot along a preliminarily set path and there is not a detection of contact with any object until an end of the path, the control unit transmits an operation enable signal to the injection molding machine.

3. The injection molding system according to claim 2, wherein the injection molding machine is automatically brought into operation when the operation enable signal is received from the control unit.

4. The injection molding system according to claim 2, wherein the control unit includes a storage unit configured to store positions of members inside the space, and generates the path on the basis of the positions of the members stored in the storage unit.

5. The injection molding system according to claim 4, wherein the control unit operates the collaborative robot in the space to detect the positions of the members contact with the collaborative robot or the hand.
